(19) United States
(12) Patent Application Publication
(10) Pub. No.: US 2024/0397571 A1
(43) Pub. Date: Nov. 28, 2024

(54) COMMUNICATION FOR SMALL DATA TRANSMISSION

(71) Applicant: Nokia Technologies Oy, Espoo (FI)

(72) Inventors: Jussi-Pekka KOSKINEN, Oulu (FI); Samuli Heikki TURTINEN, Oulu (FI); Chunli WU, Beijing (CN)

(21) Appl. No.: 18/684,018

(22) PCT Filed: Aug. 24, 2021
(86) PCT No.: PCT/CN2021/114296

§ 371 Date: Feb. 15, 2024

(51) Int. Cl. H04W 76/18

(52) U.S. Cl. CPC H04W 76/18

(57) ABSTRACT

Embodiments of the present disclosure relate to communication for SDT. A first device transmits a resume request for SDT to a second device. The second device transmits, to the first device, a message for rejecting the resume request for a part of data transmissions, said part including SDT. In this way, a resume procedure for non-SDT may still be possible. Further, not congested resources for SDT or non-SDT may be used even in case of RRC reject procedure. In addition, services may be not delayed.

### FIELD

Embodiments of the present disclosure generally relate to the field of telecommunication and in particular, to a method, device, apparatus and computer readable storage medium of communication for small data transmission (SDT).

### BACKGROUND

Typically, a terminal device in an inactive state may still have small and infrequent data traffic to be transmitted. In this event, the third generation partnership project (3GPP) Release 17 has approved SDT based on based on random access channel (RACH) and configured grant (CG) schemes in an inactive state so as to avoid signaling overhead and delay associated with transition from an inactive state to a connected state.

During SDT based on these schemes, a radio resource control (RRC) resume request for SDT may be transmitted from a terminal device to a network device. Currently, all possible RRC responses for the RRC resume request have not been decided yet. One possible response is a RRC reject message, but the problem is that it is not very optimal in current form for SDT procedure, because it will stop all the RRC resume requests even for non-SDT procedure.

### SUMMARY

In general, example embodiments of the present disclosure provide an improved solution of communication for SDT.

In a first aspect, there is provided a first device. The first device comprises: at least one processor; and at least one memory including computer program code; the at least one memory and the computer program code are configured to, with the at least one processor, cause the first device to: transmit, to a second device, a resume request for SDT; and receive, from the second device, a message for rejecting the resume request for a part of data transmissions, said part including SDT.

In a second aspect, there is provided a second device. The second device comprises: at least one processor; and at least one memory including computer program code; the at least one memory and the computer program code are configured to, with the at least one processor, cause the second device to: receive, from a first device, a resume request for SDT; and transmit, to the first device, a message for rejecting the resume request for a part of data transmissions, said part including SDT.

In a third aspect, there is provided a method of communication. The method comprises: transmitting, at a first device and to a second device, a resume request for SDT; and receiving, from the second device, a message for rejecting the resume request for a part of data transmissions, said part including SDT.

In a fourth aspect, there is provided a method of communication. The method comprises: receiving, at a second device and from a first device, a resume request for SDT; and transmitting, to the first device, a message for rejecting the resume request for a part of data transmissions, said part including SDT.

In a fifth aspect, there is provided an apparatus of communication. The apparatus comprises: means for transmitting, at a first device and to a second device, a resume request for SDT; and means for receiving, from the second device, a message for rejecting the resume request for a part of data transmissions, said part including SDT.

In a sixth aspect, there is provided an apparatus of communication. The apparatus comprises: means for receiving, at a second device and from a first device, a resume request for SDT; and means for transmitting, to the first device, a message for rejecting the resume request for a part of data transmissions, said part including SDT.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a schematic diagram illustrating an example 4-step RACH procedure according to some embodiments of the present disclosure;

FIG. 3 illustrates a schematic diagram illustrating an example 2-step RACH procedure according to some embodiments of the present disclosure;

FIG. 4 illustrates a schematic diagram illustrating a process of communication according to some embodiments of the present disclosure;

FIG. 5 illustrates a flowchart of a method of communication implemented at a first device according to example embodiments of the present disclosure;

FIG. 6 illustrates a flowchart of a method of communication implemented at a second device according to example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Currently, there are various applications that involve exchange of small and infrequency data. For example, in some applications of mobile devices, SDT may include traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may include sensor data (e.g., temperature, pressure readings transmitted periodically or in an event-triggered manner in an IoT network), metering and alerting information sent from smart meters, and/or the like.

As mentioned above, for a RRC resume request for SDT, one possible response is a RRC reject message. According to conventional solutions, upon receipt of a RRC reject message for a RRC resume request, a terminal device remains in an inactive state. If a wait time is included in the RRC reject message, the terminal device waits until the wait time expires before new RRC resume request is attempted.

It can be seen that RRC reject in current form may stop the RRC resume request for SDT and prevent one or more further RRC resume requests for SDT or non-SDT within the wait time. In fact, a network device may want to still admit non-SDT but not SDT when the system is congested, because SDT and non-SDT may be for different services (e.g. SDT typically for background messages) and it may be unbeneficial to disallow all the resources during a wait time.

In view of this, embodiments of the present disclosure provide an improved solution for a RRC reject procedure for SDT. The solution may reject a resume procedure for a part of data transmissions including SDT. In this way, a resume procedure for non-SDT may still be possible. Further, not congested resources for SDT or non-SDT may be used even in case of RRC reject procedure. In addition, services for a terminal device may be not delayed. Principles and implementations of the present disclosure will be described in detail below with reference to the figures.

### Example of Communication Network

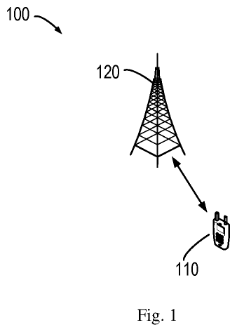

FIG. 1 illustrates a schematic diagram of an example communication network 100 in which some embodiments of the present disclosure can be implemented. As shown in FIG. 1, the communication network 100 may include a first device 110 and a second device 120. In some embodiments, the first device 110 may be a terminal device, and the second device 120 may be a network device.

Merely for illustration purpose and without suggesting any limitations as to the scope of the present disclosure, some embodiments will be described in the context where the first device 110 is a terminal device and the second device 120 is a network device. It is to be understood that, in other embodiments, the first device 110 may be a network device and the second device 120 may be a terminal device. In other words, the principles and spirits of the present disclosure can be applied to both uplink and downlink transmissions.

It is to be understood that the number and type of first and second devices as shown in FIG. 1 are only for the purpose of illustration without suggesting any limitations. The network 100 may include any suitable number and type of first and second devices adapted for implementing embodiments of the present disclosure.

As shown in FIG. 1, the first device 110 may communicate with the second device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, and the fifth generation (5G) communication protocols.

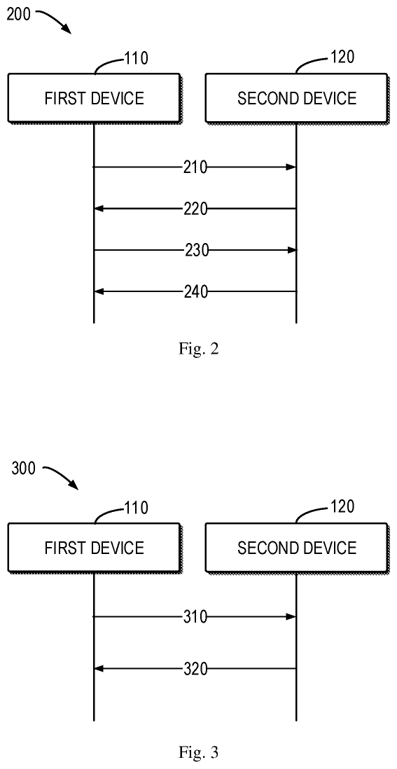

In some scenarios, the first device 110 may want to transmit, in an inactive state, data such as small and infrequent data traffic to the second device 120. In some embodiments, the first device 110 may perform a non-SDT procedure to transmit the data. In some embodiments, the first device 110 may perform a SDT procedure to transmit the data. For example, the first device 110 may perform the non-SDT procedure or the SDT procedure based on a random access procedure. This will be described in connection with FIGS. 2 and 3.

In some embodiments, the random access procedure may be a 4-step RACH procedure. FIG. 2 illustrates an example 4-step RACH procedure 200 according to some embodiments of the present disclosure. For convenience, the procedure 200 will be described with reference to FIG. 1. The procedure 200 may involve the first device 110 and the second device 120 as illustrated in FIG. 1.

As shown in FIG. 2, the first device 110 may transmit 210 a random access preamble (also referred to as Msg1) to the second device 120 on a physical random access channel (PRACH). The second device 120 may transmit 220 a random access response (also referred to as Msg2) to the second device 120 on a physical downlink shared channel (PDSCH). Then the first device 110 may transmit 230 a scheduled transmission (also referred to as Msg3) to the second device 120 on a physical uplink shared channel (PUSCH). The second device 120 may transmit 240 a contention resolution (also referred to as Msg4) to the first device 110 on PDSCH.

In some embodiments, the first device 110 may transmit a RRC resume request or a RRC setup request for non-SDT in Msg3. In this way, a non-SDT procedure based on 4-step RACH may be initiated. Upon receipt of a RRC resume message from the second device 120, the first device 110 may transmit the data in the non-SDT procedure based on 4-step RACH.

In some embodiments, the first device 110 may transmit a RRC resume request for SDT in Msg3. In this way, a SDT procedure based on 4-step RACH may be initiated. In some embodiments, the first device 110 may transmit the RRC resume request in Msg3 and transmit the data in subsequent transmission. In some embodiments, the first device 110 may transmit the RRC resume request and a portion of the data in Msg3 and transmit the remaining portions of the data in subsequent transmissions. In some embodiments, the second device 120 may transmit a message for rejecting the RRC resume request to the first device 110 in Msg4.

In some embodiments, the random access procedure may be a 2-step RACH procedure. FIG. 3 illustrates an example 2-step RACH based SDT procedure 300 according to some embodiments of the present disclosure. For convenience, the procedure 300 will be described with reference to FIG. 1. The procedure 300 may involve the first device 110 and the second device 120 as illustrated in FIG. 1.

As shown in FIG. 3, the first device 110 may transmit 310 a random access preamble and PUSCH payload (also referred to as MsgA) to the second device 120. The random access preamble may be transmitted on a physical random access channel (PRACH), and the PUSCH payload may be transmitted on PUSCH. Then the second device 120 may transmit 320 a contention resolution (also referred to as MsgB) to the first device 110 on PDSCH.

In some embodiments, the first device 110 may transmit a RRC resume request for non-SDT in MsgA. In this way, a non-SDT procedure based on 2-step RACH may be initiated. Upon receipt of a RRC resume message from the second device 120, the first device 110 may transmit the data in the non-SDT procedure based on 2-step RACH.

In some embodiments, the first device 110 may transmit a RRC resume request for SDT in MsgA. In this way, a SDT procedure based on 2-step RACH may be initiated. In some embodiments, the first device 110 may transmit the data together with the RRC resume request in MsgA. In some embodiments, the first device 110 may transmit the RRC resume request in MsgA and transmit the data in subsequent transmission. In some embodiments, the first device 110 may transmit the RRC resume request and a portion of the data in MsgA and transmit the remaining portions of the data in subsequent transmissions. In some embodiments, the second device 120 may transmit a message for rejecting the RRC resume request to the first device 110 in MsgB.

In some embodiments, the first device 110 may perform a SDT procedure based on CG scheme (not shown) to transmit the data. For example, the first device 110 may transmit a RRC resume request for SDT and the data in a CG resource. As another example, the first device 110 may transmit a RRC resume request for SDT and the data separately in different CG resources. As a response to the RRC resume request for SDT, the second device 120 may transmit a message for rejecting the RRC resume request to the first device 110.

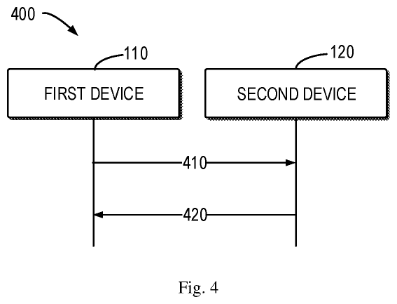

Embodiments of the present application provide a solution for rejecting the RRC resume request for SDT. The solution will be described in detail with reference to FIG. 4.

### Example Implementation of Reject for Resume Request for SDT

FIG. 4 illustrates a schematic diagram illustrating a process 400 for communication according to embodiments of the present disclosure. For the purpose of discussion, the process 400 will be described with reference to FIG. 1. The process 400 may involve the first device 110 and the second device 120 as illustrated in FIG. 1.

As shown in FIG. 4, the first device 110 transmits 410 a resume request for SDT to the second device 120. For example, when data such as small and infrequent data traffic arrives at the first device 110, the first device 110 may transmit the resume request for SDT. It is to be understood that the data may be any suitable data, and the present disclosure does not limit this aspect.

In some embodiments, the resume request may be RRCResumeRequest message.

In some embodiments, the resume request may be RRCResumeRequest1 message. In some embodiments, the resume request may comprise a resume cause indicating SDT. It should be noted that the resume request may adopt any other suitable forms, and the present disclosure does not limit this aspect.

Upon receipt of the resume request, the second device 120 may know that the resume request is for SDT. In some embodiments, if the resume request is transmitted on a random access resource reserved for SDT, the second device 120 may determine that the resume request is for SDT. In some embodiments, if Msg3 includes an indication that the resume request is for SDT, the second device 120 may determine that the resume request is for SDT. In some embodiments, if data is transmitted together with the resume request, the second device 120 may determine that the resume request is for SDT.

In this case, the second device 120 transmits 420 a message for rejecting the resume request for a part of data transmissions. The part of data transmissions includes SDT. In some embodiments, the message may be a RRCReject message. Of course, any other suitable forms are also feasible.

In this way, a resume procedure for non-SDT may still be possible. Further, not congested resources for SDT or non-SDT may be used even in case of RRC reject procedure. In addition, services for a terminal device may be not delayed. For illustration, some example embodiments will be described below in connection with Embodiments 1 to 6.

### Embodiment 1

In this embodiment, the message may indicate that the resume request is rejected for SDT but not for non-SDT.

In some embodiments, a dedicated message may be defined to dedicatedly indicate that the resume request is rejected for SDT but not for non-SDT. In some embodiments, the message may comprise information (for convenience, also referred to as first information herein) indicating that the resume request is rejected for SDT. For example, the message may comprise a bit indicating this information. Of course, this is merely an example, and the message may adopt any other suitable forms.

In this way, the second device 120 may reject SDT procedure so that only resume request for SDT is not allowed and resume request for non-SDT is still allowed.

### Embodiment 2

In this embodiment, the second device 120 may explicitly reject which one or more SDT procedures are not allowed.

In some embodiments, the message may comprise information (for convenience, also referred to as second information herein) indicating that the resume request is rejected for one or more predetermined types of SDTs.

In some embodiments, a predetermined type of SDT may comprise RACH based SDT. For example, a predetermined type of SDT may be 2-step RACH based SDT. As another example, a predetermined type of SDT may be 4-step RACH based SDT. In some embodiments, a predetermined type of SDT may comprise CG based SDT. It is to be understood that the present disclosure does not make any limitation for the type of SDT, and any other suitable types are also feasible.

In some alternative embodiments, a dedicated message may be defined to dedicatedly indicate that the resume request is rejected for a certain type of SDT.

Thus, it is possible that a certain type of SDT is not allowed, but a certain other type of SDT is allowed. For example, if said certain other type of SDT is not indicated by the second information, the first device may determine that said certain other type of SDT is allowed. It may even be possible that the message from the second device (i.e. reject message rejecting at least a certain type of SDT) indicates, additionally or alternatively, which type or types of SDT(s) is or are allowed.

### Embodiment 3

In this embodiment, one or more wait times for different data transmissions may be indicated in the message.

In some embodiments, the message may comprise information (for convenience, also referred to as third information herein) indicating at least one of the following: a wait time (for convenience, also referred to as first wait time herein) for SDT, a wait time (for convenience, also referred to as second wait time herein) for one or more predetermined types of SDT, or a wait time (for convenience, also referred to as third wait time herein) for non-SDT. The first device 110 may start a timer for a wait time for certain data transmission. If the timer is running, the first device 110 is forbidden to transmit a resume request for the certain data transmission.

In some embodiments, the first, second and third wait time may be set to be different values. In some embodiments, two or more of the first, second and third wait time may be set to be the same value. It is to be understood that the number of the wait times is not limited to three, and more or less number may also be feasible.

In some embodiments, different wait times (i.e., different values of the second wait time) may be set for different predetermined types of SDTs. For example, the predetermined types of SDTs may comprise at least one of RACH based SDT or CG based SDT. The RACH based SDT may comprise at least one of 2-step RACH based SDT or 4-step RACH based SDT. Of course, any other suitable types are also feasible. In some alternative embodiments, the same wait time may be set for different predetermined types of SDTs.

### Embodiment 4

In this embodiment, the message may indicate whether the first device 110 goes to an idle state or remains in an inactive state.

In some embodiments, the message may comprise information (for convenience, also referred to as fourth information herein) indicating whether the first device 110 goes to an idle state or remains in an inactive state. For example, the second device 120 may cause a bit or field to be comprised in the message so as to indicate that the first device 110 goes to an idle state, and cause the bit or field to be not comprised in the message so as to indicate that the first device 110 remains in an inactive state.

As another example, the second device 120 may set a first value of a bit or field comprised in the message to indicate that the first device 110 goes to an idle state, and set a second value of the bit or field to indicate that the first device 110 remains in an inactive state. Of course, these are merely examples, and any other suitable ways are also feasible.

In some embodiments, a dedicated message may be defined to dedicatedly indicate that the first device 110 goes to an idle state. In some embodiments, another dedicated message may be defined to dedicatedly indicate that the first device 110 remains in an inactive state.

### Embodiment 5

In this embodiment, upon receipt of a message for rejecting the resume request for SDT, the first device 110 may initiate a non-SDT procedure for transmitting data to the second device 120.

In some embodiments, the message may adopt an existing form of RRC reject message. In some embodiments, the message may be a dedicated message that is newly defined to indicate the rejection for SDT, for example, SDT Reject message. Of course, any other suitable forms are also suitable for the message.

In some embodiments where data was rejected to be transmitted using SDT, upon receipt of the RRC reject message, the first device 110 may initiate a non-SDT procedure to transmit the data to the second device 120. In some embodiments where data was transmitted together with the resume request that is rejected, the first device 110 may initiate a non-SDT procedure to transmit the data to the second device 120. In some embodiments where all data, that was to be transmitted using SDT procedure, was not transmitted together with the resume request for SDT that is rejected, the first device 110 may also initiate a non-SDT procedure to transmit the data to the second device 120. In some embodiments where no data was transmitted together with the resume request for SDT that is rejected, the first device 110 may also initiate a non-SDT procedure to transmit the data to the second device 120. Data transmitted using a non-SDT procedure may comprise data transmitted with the resume request for SDT and/or remaining data that was not transmitted together with the Resume Request.

In some embodiments, upon receipt of the RRC reject message, the first device 110 may initiate a non-SDT procedure to transmit subsequent data arrived at the first device 110 to the second device 120. The non-SDT procedure may be performed as that described in FIGS. 2 and 3, and thus is not repeated here.

In some embodiments, the first device 110 may not be allowed to perform SDT upon receipt of the RRC reject message, but may only initiate a non-SDT resume procedure when there is a resume event regardless it is for SDT or non-SDT RBs or if other criteria is met or not. In some embodiments, the first device 110 may consider the wait time for SDT is infinite upon receipt of the RRC reject message.

In some embodiments, the first device 110 may not be allowed to perform SDT upon receipt of the RRC reject message, but may only initiate a non-SDT procedure. In some examples, upon receipt of the RRC reject message, the first device 110 goes to IDLE mode (i.e., idle state) and may trigger a non-SDT establishment procedure when there is an establishment event regardless it is for SDT or non-SDT RBs or if other criteria is met or not. In some examples, upon receipt of the RRC reject message, the first device 110 goes to INACTIVE mode (i.e., inactive state) and may trigger a non-SDT resume procedure when there is a resume event regardless it is for SDT or non-SDT RBs or if other criteria is met or not. Alternatively, the first device 110 may trigger a SDT resume procedure when there is a resume event for SDT RB or if other criteria is met or not. To avoid possible security threat, in some examples, the first device 110 may indicate in the non-SDT resume procedure or SDT resume procedure that security key update is required, or that the current key is reused, or that the current key is used multiple times for resume procedure. Based on such indication, the second device 120 may update one or more security keys before new data is transmitted.

### Embodiment 6

In this embodiment, the second device 120 may explicitly specify that a certain radio bearer (RB) for SDT is not to be allowed.

In some embodiments, the message may comprise information (for convenience, also referred to as fifth information herein) indicating that the resume request is rejected for one or more predetermined types of RBs associated with the first device 110. In some embodiments, a predetermined type of RB may comprise signaling radio bearer (SRB). In some embodiments, a predetermined type of RB may comprise data radio bearer (DRB).

In some embodiments, the fifth information may indicate that the resume request is rejected for SDT RBs. For example, the fifth information may indicate that the resume request is rejected for SDT SRBs. As another example, the fifth information may indicate that the resume request is rejected for certain SDT DRBs. In some embodiments, the fifth information may indicate that the resume request is rejected for non-SDT RBs. It should be noted that these merely are examples, and are not intended to limit the present disclosure.

In some alternative embodiments, a dedicated message may be defined to dedicatedly indicate that the resume request is rejected for a certain type of RB.

So far, the solution for RRC reject for SDT according to the present disclosure is described. In this way, a resume procedure for non-SDT may still be possible. Further, not congested resources for SDT or non-SDT may be used even in case of RRC reject procedure. In addition, services for a terminal device may be not delayed.

### Example Implementation of Methods

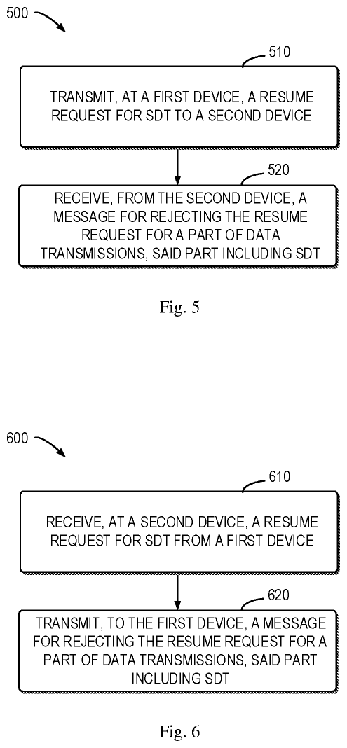

Some example methods according to embodiments of the present disclosure will now be described in detail with reference to FIGS. 5-8. However, those skilled in the art would readily appreciate that the detailed description given herein with respect to these figures is for explanatory purpose as the present disclosure extends beyond theses limited embodiments.

FIG. 5 illustrates a flowchart of a method 500 of communication implemented at a first device according to example embodiments of the present disclosure. The method 500 can be implemented at the first device 110 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

As shown in FIG. 5, at block 510, the first device 110 transmits a resume request for SDT to the second device 120.

At block 520, the first device 110 receives, from the second device 120, a message for rejecting the resume request for a part of data transmissions, said part including SDT. In some embodiments, the message may indicate that the resume request is rejected for SDT but not for non-SDT. In some embodiments, the message may comprise first information indicating that the resume request is rejected for SDT.

In some embodiments, the first device 110 may receive the message by receiving second information indicating that the resume request is rejected for one or more predetermined types of SDTs. In other words, the message may comprise the second information.

In some embodiments, the first device 110 may receive the message by receiving third information indicating at least one of first wait time for SDT, second wait time for one or more predetermined types of SDTs, or third wait time for non-SDT. In other words, the message may comprise the third information. In some embodiments, the one or more predetermined types of SDTs may comprise at least one of the following: RACH based SDT, or CG based SDT.

In some embodiments, the first device 110 may receive the message by receiving fourth information indicating whether the first device 110 goes to an idle state or remains in an inactive state.

In some embodiments, in response to receiving the message, the first device 110 may initiate a non-SDT procedure for transmitting data to the second device 120. In some embodiments, the data may comprise at least data that was rejected to be transmitted using the small data transmission. In some embodiments, the data may comprise data transmitted with the resume request.

In some embodiments, the first device 110 may receive the message by receiving fifth information indicating that the resume request is rejected for a predetermined type of RB associated with the first device 110.

The operations in the method of FIG. 5 correspond to that in the process described in FIG. 4, and thus other details are omitted here for concise. With the method of FIG. 5, a resume procedure for non-SDT may still be possible. Further, not congested resources for SDT or non-SDT may be used even in case of RRC reject procedure. In addition, services for the first device 110 may be not delayed.

Correspondingly, embodiments of the present disclosure also provide a method of communication implemented at a second device. FIG. 6 illustrates a flowchart of a method 600 of communication implemented at a second device according to example embodiments of the present disclosure. The method 600 can be implemented at the second device 120 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

As shown in FIG. 6, at block 610, the second device 120 receives a resume request for SDT from the first device 110.

At block 620, the second device 120 transmits, to the first device 110, a message for rejecting the resume request for a part of data transmissions, said part including SDT. In some embodiments, the message may indicate that the resume request is rejected for SDT but not for non-SDT. In some embodiments, the message may comprise first information indicating that the resume request is rejected for SDT.

In some embodiments, the second device 120 may transmit the message by transmitting second information indicating that the resume request is rejected for one or more predetermined types of SDTs. In other words, the message may comprise the second information.

In some embodiments, the second device 120 may transmit the message by transmitting third information indicating at least one of first wait time for SDT, second wait time for one or more predetermined types of SDTs, or third wait time for non-SDT. In other words, the message may comprise the third information. In some embodiments, the one or more predetermined types of SDTs may comprise at least one of the following: RACH based SDT, or CG based SDT.

In some embodiments, the second device 120 may transmit the message by transmitting fourth information indicating whether the first device 110 goes to an idle state or remains in an inactive state.

In some embodiments, the second device 120 may transmit the message by transmitting fifth information indicating that the resume request is rejected for a predetermined type of RB associated with the first device 110.

The operations in the method of FIG. 6 correspond to that in the process described in FIG. 4, and thus other details are omitted here for concise. With the method of FIG. 6, a resume procedure for SDT is rejected but a resume procedure for non-SDT may still be allowed.

### Example Implementation of Apparatus and Device

In some embodiments, an apparatus (for example, the first device 110) capable of performing the method 500 may comprise means for performing the respective steps of the method 500. The means may be implemented in any suitable form. For example, the means may be implemented in a circuitry or software module.

In some embodiments, the apparatus may comprise: means for transmitting, at a first device and to a second device, a resume request for SDT; and means for receiving, from the second device, a message for rejecting the resume request for a part of data transmissions, said part including SDT.

In some embodiments, the message for rejecting the resume request may indicate that the resume request is rejected for SDT, but not for non-SDT. In some embodiments, the message for rejecting the resume request may comprise first information indicating that the resume request is rejected for SDT.

In some embodiments, the means for receiving the message may comprises means for receiving second information indicating that the resume request is rejected for one or more predetermined types of SDTs. In some embodiments, the means for receiving the message may comprises means for receiving third information indicating at least one of the following: first wait time for SDT, second wait time for one or more predetermined types of SDTs, or third wait time for non-SDT. In some embodiments, the one or more predetermined types of SDTs may comprise at least one of the following: RACH based SDT, or CG based SDT.

In some embodiments, the means for receiving the message may comprises means for receiving fourth information indicating whether the first device goes to an idle state or remains in an inactive state.

In some embodiments, the apparatus may further comprise means for, in response to receiving the message, initiating a non-SDT procedure for transmitting data to the second device. In some embodiments, the data may comprise at least data that was rejected to be transmitted using the SDT. In some embodiments, the data may comprise data transmitted with the resume request.

In some embodiments, the means for receiving the message may comprises means for receiving fifth information indicating that the resume request is rejected for a predetermined type of a radio bearer associated with the first device.

In some embodiments, an apparatus (for example, the second device 120) capable of performing the method 600 may comprise means for performing the respective steps of the method 600. The means may be implemented in any suitable form. For example, the means may be implemented in a circuitry or software module.

In some embodiments, the apparatus may comprise: means for receiving, at a second device, a resume request for SDT from a first device; and means for transmitting, to the first device, a message for rejecting the resume request for a part of data transmissions, said part including SDT.

In some embodiments, the message for rejecting the resume request may indicate that the resume request is rejected for SDT, but not for non-SDT. In some embodiments, the message for rejecting the resume request may comprise first information indicating that the resume request is rejected for SDT.

In some embodiments, the means for transmitting the message may comprises means for transmitting second information indicating that the resume request is rejected for one or more predetermined types of SDTs. In some embodiments, the means for transmitting the message may comprises means for transmitting third information indicating at least one of the following: first wait time for SDT, second wait time for one or more predetermined types of SDTs, or third wait time for non-SDT. In some embodiments, the one or more predetermined types of SDTs may comprise at least one of the following: RACH based SDT, or CG based SDT.

In some embodiments, the means for transmitting the message may comprises means for transmitting fourth information indicating whether the first device goes to an idle state or remains in an inactive state.

In some embodiments, the means for transmitting the message may comprises means for transmitting fifth information indicating that the resume request is rejected for a predetermined type of a radio bearer associated with the first device.

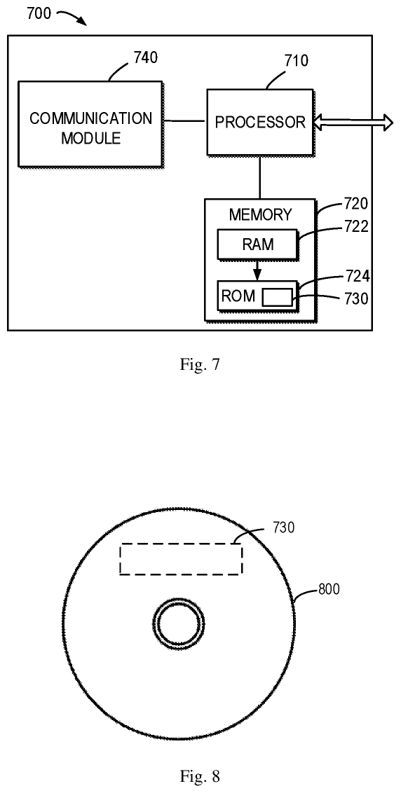

FIG. 7 is a simplified block diagram of a device 700 that is suitable for implementing embodiments of the present disclosure. The device 700 may be provided to implement the first device or the second device, for example the first device 70 or the second device 120 as shown in FIG. 1. As shown, the device 700 includes one or more processors 710, one or more memories 720 coupled to the processor 710, and one or more communication modules 740 (such as, transmitters and/or receivers) coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 1-6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500-600 as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program code;
the at least one memory and the computer program code configured to, with the at least one processor, cause the first device to:
transmit, to a second device, a resume request for small data transmission; and
receive, from the second device, a message for rejecting the resume request for a part of data transmissions, said part including small data transmission.

2. The first device of claim 1, wherein the message for rejecting the resume request indicates that the resume request is rejected for small data transmission, but not for non-small data transmission.

3. The first device of claim 1, wherein the message for rejecting the resume request comprises first information indicating that the resume request is rejected for small data transmission.

4. The first device of claim 1, wherein the first device is caused to receive the message by:
receiving second information indicating that the resume request is rejected for one or more predetermined types of small data transmissions.

5. The first device of claim 1, wherein the first device is caused to receive the message by:
receiving third information indicating at least one of the following:
first wait time for small data transmission,
second wait time for one or more predetermined types of small data transmissions, or
third wait time for non-small data transmission.

6. The first device of claim 4, wherein the one or more predetermined types of small data transmissions comprise at least one of the following:
random access based small data transmission, or
configured grant based small data transmission.

7. The first device of claim 1, wherein the first device is caused to receive the message by:
receiving fourth information indicating whether the first device goes to an idle state or remains in an inactive state.

8. The first device of claim 1, wherein the first device is further caused to:
in response to receiving the message, initiate a non-small data transmission procedure for transmitting data to the second device.

9. The first device of claim 8, wherein the data comprises at least data that was rejected to be transmitted using the small data transmission.

10. The first device of claim 8, wherein the data comprises data transmitted with the resume request.

11. The first device of claim 1, wherein the first device is caused to receive the message by:
receiving fifth information indicating that the resume request is rejected for a predetermined type of a radio bearer associated with the first device.

12. The first device of claim 1, wherein the first device is a terminal device, and the second device is a network device.

13. A second device comprising:
at least one processor; and
at least one memory including computer program code;
the at least one memory and the computer program code configured to, with the at least one processor, cause the second device to:
receive, from a first device, a resume request for small data transmission; and
transmit, to the first device, a message for rejecting the resume request for a part of data transmissions, said part including small data transmission.

14. The second device of claim 13, wherein the message for rejecting the resume request indicates that the resume request is rejected for small data transmission, but not for non-small data transmission.

15. The second device of claim 13, wherein the message for rejecting the resume request comprises first information indicating that the resume request is rejected for small data transmission.

16. The second device of claim 13, wherein the second device is caused to transmit the message by:
transmitting second information indicating that the resume request is rejected for one or more predetermined types of small data transmissions.

17. The second device of claim 13, wherein the second device is caused to transmit the message by:
transmitting third information indicating at least one of the following:
first wait time for small data transmission,
second wait time for one or more predetermined types of small data transmissions, or
third wait time for non-small data transmission.

18-21. (canceled)

22. A method of communication, comprising:
transmitting, at a first device and to a second device, a resume request for small data transmission; and
receiving, from the second device, a message for rejecting the resume request for a part of data transmissions, said part including small data transmission.

23. The method of claim 22, wherein the message for rejecting the resume request indicates that the resume request is rejected for small data transmission, but not for non-small data transmission.

24-25. (canceled)

26. The method of claim 22, wherein receiving the message comprises:
receiving third information indicating at least one of the following:
first wait time for small data transmission,
second wait time for one or more predetermined types of small data transmissions, or
third wait time for non-small data transmission.

27-46. (canceled)
